(19) United States
(12) Patent Application Publication
(10) Pub. No.: US 2013/0001171 A1
(43) Pub. Date: Jan. 3, 2013

(54) Process for controlling hardness in open recirculating systems

(76) Inventors: Rick Harve Maxey, Sandia, TX (US); James Russell Matthews, Corpus Christi, TX (US)

(21) Appl. No.: 13/135,179

(22) Filed: Jun. 28, 2011

(51) Int. Cl. C02F 5/08

(52) U.S. Cl. 210/709; 210/153

(57) ABSTRACT

A process and system are provided for controlling hardness in recirculated cooling water, wherein chemical addition is independent of pH determination. Hardness is determined in a make-up water stream provided to a cooling water system. Chelant is continuously added to the make-up water stream, the amount of chelant being a function of the make-up water hardness. A side stream is circulated from the cooling water system to a reactor. A conditioner is added to the reactor based on the amount of chelant. The conditioned side stream is retained within the reactor to precipitate a percentage of suspended solids, and a portion of the precipitated solids are removed as necessary to maintain a fluid bed level. A clarified water stream is withdrawn from the reactor and returned to the cooling water system circulation. A chelant concentration of from 600 to 800 ppm is maintained in the system.

### FIELD OF THE INVENTION

The field of the invention is water treatment. More specifically, the invention relates to the treatment of water used in systems wherein water is circulated for repeated use, such as evaporative cooling systems.

### BACKGROUND OF THE INVENTION

Evaporative cooling water is used to cool various liquids or gases, in cooling systems using an evaporative cooling unit, a heat exchanger and a source of makeup water piped together in a circulating line. The heat exchanger warms the circulating water, which is circulated back to the cooling tower. The warmed water cascades down inside the cooling tower, and cools by evaporation, due to the fresh air flowing counter-current through the tower fill section.

Such evaporative cooling systems, of which cooling towers are one example, operate on the principle that the latent heat of vaporization of the water being evaporated subtracts energy from the system, thus, reducing the temperature of the remaining water in the system. Only some of the water is evaporated, however, and the salts in the remaining water are manifested in increasing dissolved solids. The most common dissolved solids in domestic water are bicarbonates, chlorides, and sulfates of calcium, magnesium and sodium. When water containing calcium bicarbonate is heated, as in cooling of air conditioning systems or other equipment, the heat in the heat exchanger will strip off one molecule of carbon dioxide, rendering the remaining calcium salt to calcium carbonate (limestone), also known as “scale.” This precipitate, the scale, is less soluble in warm water than in cool water and has very poor thermal conductivity, thus reducing heat exchanger efficiency. The scale also becomes less soluble as the pH of the circulating water increases. A higher rate of solids precipitation occurs in a high pH environment.

To maintain a concentration of solids that reduces the formation of scale, fresh water is added from a makeup water source to replace the water lost due to evaporation. Also, water with high concentrations of solids are “wasted” or “blown down” through the system drain to a sewer or ditch, and this must be replaced with makeup water as well.

A mass balance of water across the cooling tower system may be represented by the following equation:

M=E+D+W

where:

M=Make-up water in gal/min

D=Blow Down, or Draw-off water in gal/min

E=Evaporated water in gal/min

W=Windage, or drift, loss of water in gal/min

The concentration of solids in the cooling water system is related to the concentration of solids in the make-up water by cycles of concentration, or cycles, as shown in the following relationships.

Cycles=XC/XM=M/(D+W)=M/(M−E)=1+{E/(D+W)}

where:

X=Concentration in ppmw (of any completely soluble salts; usually chlorides)

XC=Concentration of soluble salts in circulating water (C), in ppmw

C=Circulating water in gal/min

XM=Concentration of soluble salts in make-up water (M), in ppmw

Assuming windage is negligible, the water balance may be simplified such that total makeup water (M) volume is the sum of evaporated water (E) plus blow down water (D).

M=E+D

For evaporative cooling systems, a “concentration ratio” (CR) is defined as the volume of makeup water divided by the volume of blow down water.

CR=M/D

Prior art systems are typically characterized by a CR of less than 10, for example about 3, depending upon the quality (i.e., hardness) of the makeup water. A large concentration ratio is achieved through reduction in the blow down volume. Restated for blow down volume, the equation is:

D=E/(CR−1)

Several processes are used to chemically treat evaporative cooling water in order to reduce scale, a number of which are discussed in U.S. Pat. No. 5,730,879 to Wilding, et al. Various combinations of chemicals and inorganic acids are used, but, for example, the current state-of-the-art limits a cooling system using makeup water with 150 parts per million hardness, to a concentration ratio of less than 6, when the total circulating system has a total maximum alkalinity of 600 ppm. In this situation, a cooling tower evaporating 5 million gallons of water per day, with a concentration ratio of 6, wastes 1 million gallons of water per day. In such a system, the blow down water usually contains between 600 and 900 ppm hardness, and requires blow down after approximately 10 volumes of system water have been evaporated (referred to as “cycles of concentration”).

U.S. Pat. No. 5,730,879, referenced above, utilizes a side stream system for treating a portion of the total evaporative cooling water, in an effort to reduce scale formation at the heat exchanger. Cation resin is used to remove water hardness. The resin beads must be regenerated with salt, acid or caustic (depending on the resin used), and then water washed to remove calcium ions. The regeneration solutions become the blow down.

Other known treatments add chemicals directly into the primary circulation line and have some success in lowering scale formation and increasing the concentration ratio and cycles of concentration. The additive most commonly used is sulfuric acid, which converts calcium carbonate into the more soluble calcium sulfate. Both calcium carbonate and calcium sulfate precipitate more readily as the temperature of the evaporative cooling water increases. In addition, the relatively high concentration of sulfuric acid renders it potentially corrosive. Sulfuric acid can also be hazardous to handle.

The side stream system has also been adapted to use a buffer and caustic to precipitate hardness. For example, U.S. Pat. No. 7,157,008 to Owens is drawn to an apparatus and process for water conditioning in which a conditioner is added to a side stream before entering a reactor and a buffer is added to the side stream exiting the reactor. The Owens '008 process is pH controlled.

While the above-described processes have been relatively successful at controlling hardness, existing procedures tend to:
(1) accumulate sludge at the side stream injection point, thereby restricting water flow and inhibiting the process;
(2) present a hazardous maintenance environment in that when the injection point becomes fouled, the operator is exposed to very high pH material (e.g., potassium hydroxide);
(3) rely on pH readings which may be unreliable since pH probes and controllers do not stay in calibration;
(4) be cost-ineffective due to chemical regeneration costs and loss of regeneration solution; and
(5) present a workplace hazard with respect to handling a very low pH material (e.g., glycolic acid, pH 1.0).

Systems that rely on ion exchange require large amounts of water. Systems that require pH sensing equipment to regulate chemical addition are limited by the unreliability of pH sensors, which require frequent calibration for accuracy. As the pH meters or probes drift from calibration, proper feeds are interrupted, putting stress on the system, reducing flow, and increasing maintenance and chemical costs.

Accordingly, there remains a need for effective hardness control that is reliable and cost-effective that minimizes water use.

### SUMMARY OF THE INVENTION

A process is therefor provided for controlling hardness in recirculated cooling water, wherein chemical addition is independent of pH determination, comprising the following steps. Hardness is determined in a make-up water stream provided to a cooling water system. An amount of chelant is continuously added to the make-up water stream, the amount of chelant being a function of the make-up water stream hardness. A water side stream is circulated from the cooling water system to a reactor. A conditioner is added to the reactor, the amount of conditioner being a function of the amount of chelant added. The conditioned side stream is retained within the reactor for a retention time sufficient to precipitate a percentage of suspended solids from the conditioned side stream water. A clarified water stream is withdrawn from the reactor and returned to the cooling water system circulation. Precipitated solids are withdrawn from the reactor as necessary to maintain a fluid bed level based upon the height of the reactor.

Other aspects and advantages of the present invention are described in the detailed description below and in the claims.

### BRIEF DESCRIPTION OF THE DRAWINGS

The invention is described in detail below with reference to the appended drawings, wherein like numerals designate similar parts. In the Figures:

FIG. 1 illustrates a simplified flow diagram of the inventive treatment process; and

FIG. 2 illustrates a suitable reactor according to the invention.

### DETAILED DESCRIPTION OF THE INVENTION

The invention is described in detail below with reference to several embodiments and numerous examples. Such discussion is for purposes of illustration only. Modifications to particular examples within the spirit and scope of the present invention, set forth in the appended claims will be readily apparent to one of skill in the art. Terminology used herein is given its ordinary meaning consistent with the exemplary definitions set forth immediately below. For example, ppmw refers to parts per million by weight, unless specified otherwise.

As used herein, the term “evaporative cooling system” means a cooling system having at least an evaporative cooling unit (of which a cooling tower is but one example), a heat exchanger in circulatory communication with the evaporative cooling unit (by means such as circulating pipe and one or more pumps), a makeup water source (with means for adding the makeup water to the circulation), and a blow down capability (for removing water from the circulation).

The term “makeup water” is used herein to refer to fresh or replacement water added to the cooling system to replace evaporated and blow down water lost from the system.

As used herein, the term “side stream” refers to a fraction of circulating water in the evaporative cooling system that is removed from the system for treatment in a reactor.

As used herein, the term “conditioner” or “conditioning agent” refers to caustic, e.g. potassium hydroxide, sodium hydroxide, and calcium hydroxide. Conditioner is also referred to as “adjuvant.”

As used herein, the term “chelant” or “assisting agent” refers to salts of organic acids, such as glycolic acid, alpha-hydroxyacetic acid, acetic acid, malic acid, tartaric acid, ascorbic acid, and citric acid. Preferably, the chelant is a salt of glycolic acid, and more preferably potassium glycolate. Potassium glycolate has a pH of about 7.0 to 8.0, such as 7.5, and may be prepared according the following chemical equation:

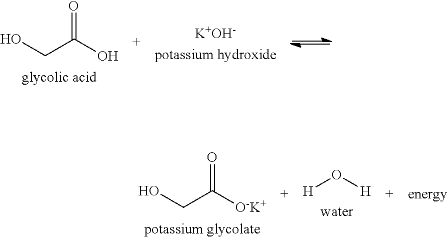

As used herein, the term “lines” includes conduit, piping, tubular members, and the like, that are suitable for transporting liquids.

The process according to the invention removes a percentage of the hardness, or calcium, magnesium and silica present, in open recirculating evaporative cooling water systems to a non-scaling level, which is determined by the end-user; for example, of 800 to 1000 ppm hardness measured as calcium carbonate.

A non-acid chelant, having a neutral pH, is added to the make up water supply at the tower basin as a pretreatment process. The chelant serves to inactivate hardness present in the cooling water. The amount of chelant added is based on the hardness, in parts per million by weight, or pounds per 1000 gallons, imported in the make-up water. Chelant is added in an amount sufficient to maintain a weight ratio of chelant:hardness in the cooling system of about 3:1. The ratio may be optimized to give the best floc in the reaction chamber. The amount of chelant added is determined as a function of make up water flowrate and hardness level. A side stream of cooling water is drawn from the tower at the recirculation pumps (typically about 0.5% of the total recirculation rate on the system) and is fed to a reaction chamber by injection into the bottom of the reactor, tangentially to the sidewall to create a circular flow that gives excellent mixing without the problem of fluid bed build in the injection line. The velocity of the side stream keeps the lines open.

An adjuvant is also added to the side stream at the reactor inlet, causing calcium and magnesium present to precipitate forming a sludge, fluid bed, or slurry. The amount of adjuvant added is in an adjuvant:chelant weight ratio of from about 1:1 to about 4:1, such as 2:1 or 3:1. This amount is added to the reactor to strip calcium and magnesium off the chelant bond along with enough hydroxide (from the adjuvant) to form magnesium silicate (e.g, from magnesium glycolate). An insufficient amount of adjuvant will fail to remove hardness, while an excess amount may affect solubility and interfere with hardness removal. The sludge then sinks to the bottom of the reactor and is removed as needed using an automated valve and timer to maintain a fluid bed height in the reactor of about 30% of the reactor height. A predetermined retention time (for example, about 5 minutes per gallon of flow rate) is maintained in the reactor to facilitate fluid bed formation and clarification of product water.

Clarified water, containing chelant freed from bound calcium and magnesium, is removed through a valve at the top of the reactor, filtered, and returned to the tower basin as partially-softened water with total hardness lowered to a non-scaling level. Any suitable filter may be used, for example a 75 micron filter. As a result, the calcium and magnesium levels in water recirculating to evaporative condensers and cooling towers are reduced. Blow down rates are determined by the volume of fluid bed generation, which is a function of the amount of hardness removed from the cooling water system.

Chelant may be lost as a result of windage, or water blown from the cooling tower.

The inventive process does not require disposal of brine, a drawback of ion-exchange water softening systems.

In the present invention, chemical addition is not dependent upon pH monitoring. Chemical addition is determined by mass balance. The process is also not dependent upon dissolved solids levels.

Preferably, the chelant used is potassium glycolate having a pH of 7.0 to 8.0. Also, preferably, the adjuvant, or conditioner, used is sodium hydroxide or potassium hydroxide having a pH of 12.0 to 13.0.

Other components may be added as necessary, such as a biocide to control biological growth to prevent slime development. A corrosion inhibitor may be added to the cooling water at the tower basin if desired.

The inventive process differs from a conventional system especially in the following ways:
(a) Chemical addition is determined by the mineral content of the make-up water, not by the pH of any stream in the system;
(b) Chelant is added at the make-up water supply to the tower basin, not the clarified water from the reactor;
(c) Fluid bed is drawn off from the side of the reactor at a distance of from 15% to 40% of the reactor height, for example, 30%, from the bottom of the reactor, rather than drawing fluid bed from the bottom of the reactor; and
(d) The chelant used is a salt of an organic acid, not an organic acid.

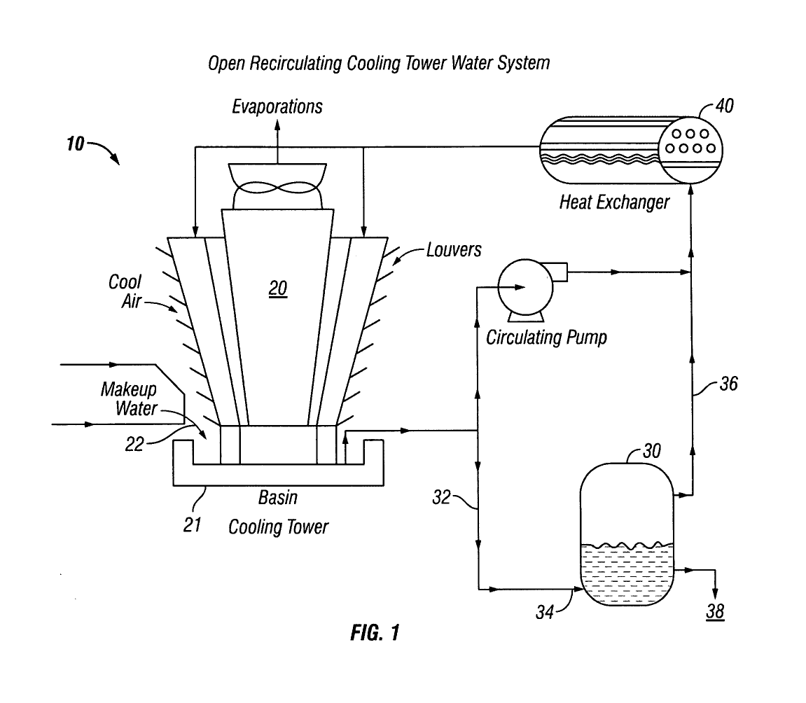

A simplified inventive evaporative cooling system 10 is depicted in FIG. 1 and includes an evaporative cooling tower 20 and basin 21, a reaction chamber 30 and a heat exchanger 40. The present invention virtually eliminates blow down from normal operation, thereby providing substantial water and cost savings. Generally, the only water removed from the system is either evaporated or discharged (wasted) to suspend entrained floc in wasted sludge. Make-up water and chelant are provided to the tower basin 21 via line 22. Water is circulated between the cooling tower and the heat exchanger in a circulating line including a cool water supply line and a warm water return line. A side stream 32 is drawn from the cool water supply line, combined with a conditioner stream added at an injection point 34 into the bottom of the reactor, and provided to reaction chamber 30. Clarified water 36 is drawn from the top of the reactor, and returned to cooling tower 20 via the heat exchanger 40. Periodically, the fluid bed is removed via line 38.

Conventional water conditioning methods typically involve injecting various additives, such as inhibitors, dispersants, and acids, directly into the cool water supply line.

Contrary to a conventional approach, the present invention does not control introduction of chemicals as a function of pH. In fact, pH monitoring is not necessary for water conditioning purposes according to the process of the invention. This is due, at least in part, to the use of a salt of an organic acid, rather than the use of an organic acid, as chelant.

Sludge is removed based on bed height and density. The bed is generally removed at 30% of the reactor height. The sludge comprises calcium carbonate and magnesium carbonate and, as a non-hazardous material, can be disposed of in sanitary sewers or landfills with no additional treatment. This is a surprising advantage over other hardness removal systems.

The reactor, or reaction vessel, according to the invention, typically comprises an approximately cylindrical unit having a receiving port to receive side stream water entering the vessel, an exit port for returning clarified water to the cooling system, and two fluid bed discharge ports for controlling the fluid bed level.

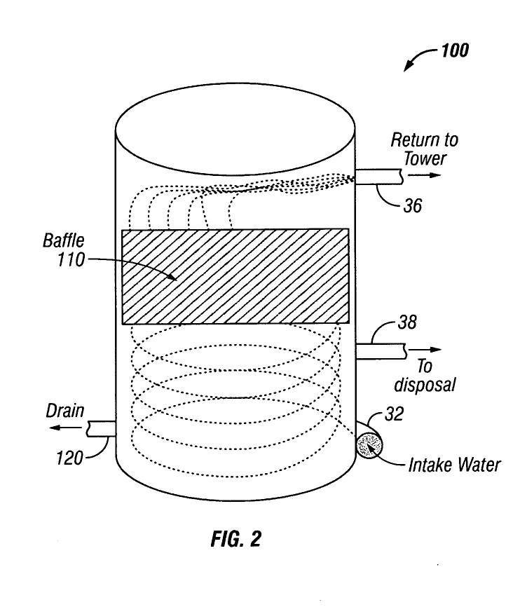

In one embodiment illustrated in FIG. 2, the reactor 100 comprises a baffle 110. Cooling system water enters the reactor 100 via sidestream 32 and circulates through the reactor 100. Clarified water returns to the cooling tower as shown in FIG. 1 via line 36. Sludge is removed at 38 for disposal. The baffle 110 serves to stop a spinning movement of water in the top of the reactor to allow for settling. A drain 120 is provided for periodic maintenance.

In the reactor, suspended calcium carbonate solids precipitate from the evaporative cooling water into the reactor. These solids, being heavier than water, tended to gravitate toward the bottom of the tank in a fluid consistency.

Prospectively, salts of other organic acids may be substituted for potassium glycolate, and will perform the desired function, although it is anticipated that a larger volume will be required to perform at the level of the potassium glycolate.

An important advantage of this process is a reduction in blow down of as much as 90-95%. This makes the process extremely economical due to significant water savings, and due to conservation of water is a “Green Technology”.

The process according to the invention removes calcium and magnesium with sludge removal, and thereby eliminates hard water scaling by reducing hardness levels to below about 1000 ppm, for example, measured as calcium carbonate. Hardness may be determined using a HACH hardness test or any other suitable method known in the art. A soap test, for example, is not a suitable method.

With the hardness reduction comes a significant reduction in silica (precipitated as MgSiO₂), a major scale former in cooling tower treatment programs. The reduction in scaling, and the reduction in silica in particular, is surprising. The removal of silica eliminates silica as a controlling factor in cycles of concentration.

### Example 1

A cooling tower was operated using only superficial hardness removal by blow down for twelve months (2003). During this time, corrosion inhibitors (60 ppm as product), surfactants and dispersants were added to the cooling tower basin. The amount of make-up water and the costs for make-up water and blow down were documented for that time period.

The hardness removal system according to the invention was installed and run for an additional twelve months (2004). A sidestream was established and a reactor was installed as shown in FIG. 1. Make-up water hardness was monitored by HACH test kit daily. Potassium glycolate was added at the make-up water supply at a rate of 3 ppm per ppm hardness in the make-up water. Potassium hydroxide was added to the bottom of the reactor in an amount of 3 times the amount of potassium glycolate added. Corrosion inhibitor was reduced to 5 ppm as product. Blow down was removed from the reactor with fluid bed at 30% of the reactor height. Clarified water from the reactor was returned to the cooling tower as shown in FIG. 1. The equipment cost for the conversion was $6,500. The amount of make-up water and the costs for make-up water and blow down were again documented. The amounts and costs in 2004 U.S. dollars are documented in the table below.

| | Make-up water, | Evaporation, | Blow-down, | |
|---|---|---|---|---|
| | thousand | thousand | thousand | Total |
| Year | gallons | gallons | gallons | costs, $ |
| 2003 | 9925 | 6771.4 | 3153.6 | 43,401.49 |
| 2004 | 4980 | 4939.485 | 40.515 | 16,017.03 |
| Reduction, % | 49.8 | 27.0 | 98.7 | 63.1 |

The nearly 5 million gallon difference in make-up water is entirely a function of the reduction in blow down discharge. In 2003, the blow-down rate was 31.8% of the make-up water rate, resulting in a system that achieved 3.15 cycles of concentration. The chelant/adjuvant hardness removal allowed the system to reduce blow-down in 2004 to 0.81% of the make-up water rate, achieving an average of 25 cycles of concentration.

As is readily apparent from the data in the table, above, the present invention offers substantial savings, on the order of 63% of the water costs, and reduced water demand by 50%. The process according to the invention allowed the system to blow-down 99% less water. The system according to the invention provided a return on investment of 2.85 months. Subsequent to this period, the blow down valve was generally closed for four years, evidencing a sharp reduction in the amount of blow down required. The amount of water conserved, and the corresponding cost savings, is surprising and significant.

### Example 2

A cooling tower was operated with hardness removal according to the invention for 48 months. During this time, on average, 472,272 gallons of make-up water were added per month, and 23,013 gallons of blow down water were discharged per month. On average, 449,259 gallons of water evaporated each month. Therefore, this system provided an average of 20.5 cycles of concentration.

Glycolic acid provides immediate clean-up of reactor down-stream piping; the glycolate form does not. However, with a properly engineered reactor, this is not necessary. In some embodiments, a small amount of glycolic acid may be added, or the pH may be adjusted between about 7.0 and about 5.5 as necessary.

Alternative chelants may be selected from salts of the following acids: acetic acid; ascorbic acid; malic acid; maleic acid; tartaric acid; lactic acid; and citric acid. However, applicants have found that these acids are not as efficient as a glycolate salt.

There is thus provided a process for controlling hardness in recirculated cooling water, wherein the chelant and conditioner addition are independent of pH determination. The process comprises the following steps. A hardness level is determined in a make-up water stream provided to a cooling water system. Chelant is continuously added to the make-up water stream, the amount of chelant being a function of the make-up water stream hardness. A circulated water side stream is established from the cooling water system to a reactor. A conditioner is added to the reactor, the amount of conditioner being a function of the amount of chelant added. The conditioned side stream is retained within the reactor for a retention time sufficient to precipitate a percentage of suspended solids from the conditioned side stream water. A clarified water stream is withdrawn from the reactor and returned to the cooling water system circulation. Precipitated solids are withdrawn to maintain a fluid bed level based upon the height of the reactor, generally such that the fluid bed height is maintained at a level equal to about 15% to about 40% of the reactor height. A fraction of the water in the cooling water system circulation is optionally removed with a fraction of precipitated solids as blow down. In one embodiment, the side stream is introduced to the reactor at an injection point at the bottom of the reactor tangentially to a reactor sidewall to maintain a substantially circular flow within the reactor. The clarified water stream is optionally filtered before returning to the cooling water system circulation, for example at a position such that the clarified water stream enters a heat exchanger.

The chelant typically has a pH greater than about 6 and less than about 9 and is generally added in a ratio of chelant to make-up water hardness, measured as calcium carbonate, of from 1:1 to 10:1, on a weight basis, such that the chelant is maintained in the cooling water system, for example at a concentration of 600 to 800 parts per million by weight. Preferably, the chelant is potassium glycolate. The conditioner is generally added in a ratio of conditioner to chelant of from 1:1 to 5:1, on a weight basis. Preferably, the conditioner is selected from potassium hydroxide, sodium hydroxide, and combinations thereof.

In another embodiment, a system is provided for controlling hardness in recirculating cooling water. In this embodiment, the system comprises an evaporative cooling tower with a basin; a heat exchanger; a reactor for precipitation of suspended solids; and means of circulating water between the cooling tower and the heat exchanger and between the cooling tower or the heat exchanger and the reactor. A make-up water supply is provided to the cooling tower and a chelant supply is provided to the make-up water supply, generally in a concentration of from 1 to 3 ppm by weight based on the amount of make-up water supplied to the cooling tower. The reactor is provided with a conditioner supply and a means of removing solids from the reactor. In the system according to the invention, water introduced to the reactor enters tangentially to the reactor sidewall. Optionally, a filter is provided at an outlet of the reactor.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A process for controlling hardness in recirculated cooling water, comprising the steps of:
a. determining hardness in a make-up water stream provided to a cooling water system;
b. continuously adding an amount of chelant to the make-up water stream, the amount of chelant being a function of the make-up water stream hardness;
c. establishing a circulated water side stream from the cooling water system to a reactor;
d. adding a conditioner to the reactor, the amount of conditioner being a function of the amount of chelant added;
e. retaining the conditioned side stream within the reactor for a retention time sufficient to precipitate a percentage of suspended solids from the conditioned side stream water;
f. withdrawing a clarified water stream from the reactor and returning the clarified water stream to the cooling water system circulation; and
g. withdrawing precipitated solids to maintain a fluid bed level based upon the height of the reactor;
wherein the chelant and conditioner addition are independent of pH determination.

2. The process according to claim 1, wherein a concentration of about 600 to about 800 parts per million chelant is maintained in the cooling water system.

3. The process according to claim 1, wherein the chelant has a pH greater than about 6 and less than about 9.

4. The process according to claim 1, wherein the side stream is introduced to the reactor at an injection point at the bottom of the reactor tangentially to a reactor sidewall to maintain a substantially circular flow within the reactor.

5. The process according to claim 1, wherein the clarified water stream is filtered before returning to the cooling water system circulation.

6. The process according to claim 1, wherein the clarified water stream is returned to the cooling water system circulation at a position such that the clarified water stream enters a heat exchanger.

7. The process according to claim 1, wherein the fluid bed height is maintained at a level equal to about 15% to about 40% of the reactor height.

8. The process according to claim 1, wherein a fraction of the water in the cooling water system circulation is removed with a fraction of precipitated solids as blow down.

9. The process according to claim 1, wherein the chelant is potassium glycolate.

10. The process according to claim 1, wherein the conditioner is selected from potassium hydroxide, sodium hydroxide, and combinations thereof.

11. The process according to claim 1, wherein the chelant is added in a ratio of chelant to hardness, measured as calcium carbonate, of from 1:1 to 10:1, on a weight basis.

12. The process according to claim 1, wherein the conditioner is added in a ratio of conditioner to chelant of from 1:1 to 5:1, on a weight basis.

13. A system for controlling hardness in recirculating cooling water, the system comprising:
a. an evaporative cooling tower with a basin;
b. a heat exchanger;
c. a reactor for precipitation of suspended solids;
d. means of circulating water between the cooling tower and the heat exchanger;
e. means for circulating water between the cooling tower or the heat exchanger and the reactor;
f. a make-up water supply provided to the cooling tower;
g. a chelant supply provided to the make-up water supply;
h. a conditioner supply provided to the reactor; and
i. a means of removing solids from the reactor;
wherein water introduced to the reactor enters tangentially to the reactor sidewall; and wherein a chelant concentration of from 1 to 3 ppm is provided to the make-up water provided to the cooling tower.

14. The system according to claim 13, further comprising a filter provided at an outlet of the reactor.
